(19) United States
(12) Patent Application Publication
(10) Pub. No.: US 2012/0228570 A1
(43) Pub. Date: Sep. 13, 2012

(54) Battery Lift Jack

(76) Inventor: Michael Marshall, Orchard Park, NY (US)

(21) Appl. No.: 13/043,710

(22) Filed: Mar. 9, 2011

(51) Int. Cl. B66F 5/00

(52) U.S. Cl. 254/2 B

(57) ABSTRACT

A battery lift jack assembly for lifting batteries comprising: a platform for placement of a battery, where the platform is suspended on a platform pedestal, where the pedestal moves vertically to raise the platform to a desired height; a base that is provided on wheels, where the platform pedestal is secured on the base; a jack assembly for moving the platform pedestal vertically; and a connector, where the connector joins the platform pedestal to the jack assembly and moves vertically along the jack column. The jack assembly includes a jack handle and jack column. The platform may further include lips, which help to secure the battery in a stationary position while the platform, is moved vertically.

### BACKGROUND OF THE INVENTION

1. Field of Invention

The present invention relates to a battery lift jack that is utilized to lift batteries for refrigeration units.

2. Description of Related Art

Many times workers in various professions such as contractors, mechanics and carpenters may be required to lift heavy objects above their waist and on occasion above their head levels. Consequently, the lifting of the heavy objects at these heights can cause injury to the worker and therefore mechanical assistance is the preferred method in lifting objects off the ground. Many devices have been developed over the years to assist in lifting heavy objects such as hoists and scissor lifts. Hoists usually employ the use of a chain and pulley system where the hoist may be in a stationary or portable position. Normally the object to be lifted is placed on a hook and pulled through a pulley system lifting it to the desired height. Scissor lifts are another method that is employed for lifting heavy objects. Many times scissor lifts are portable and achieve their name due to the mechanism employed to lift a platform that may hold the object being lifted. The arms are placed in a scissor design or configuration and then moved inward towards each other to effectively lift the platform that is placed on the scissor assembly.

Hoists and scissor lifts are just two examples of devices used to lift objects. Other devices may employ the use of hydraulics or pneumatic actuators for lifting purposes. One desirable application of a lift may be associated with refrigerated trailers, which require the use of batteries within the refrigeration unit. The installation of the battery in the refrigeration unit many times requires the lifting of the battery above the head of the worker during the installation. Consequently, it would be advantageous to have a lift that could maneuver a battery up to the desired height and therefore provide a means to alleviate the manual lifting of the battery for installation into a refrigeration unit.

### SUMMARY OF THE INVENTION

The present invention relates to a battery lift jack assembly for lifting batteries comprising: a platform for placement of a battery, where the platform is suspended on a platform pedestal, where the pedestal moves vertically to raise the platform to a desired height; a base that is provided on wheels, where the platform pedestal is secured on the base; a jack assembly for moving the platform pedestal vertically; and a connector, where the connector joins the platform pedestal to the jack assembly and moves vertically along the jack column. The jack assembly includes a jack handle and jack column. The platform may further include lips, which help to secure the battery in a stationary position while the platform, is moved vertically.

### BRIEF DESCRIPTION OF DRAWINGS

FIG. 1 depicts a battery jack lift in accordance with the present invention.

### DETAILED DESCRIPTION

The present invention relates to a battery jack lift for lifting a refrigeration unit battery to a desired height for installation into a refrigerated unit of a refrigerated trailer. The battery lift jack in accordance with the present invention includes a base that supports the jack mechanism along with a pedestal that stands vertically to support a platform. The battery is placed upon a platform and raised vertically through operation of the jack. The jack also lowers the platform after the battery has been removed. The battery lift according to the present invention is mobile and may be moved about as desired by the user.

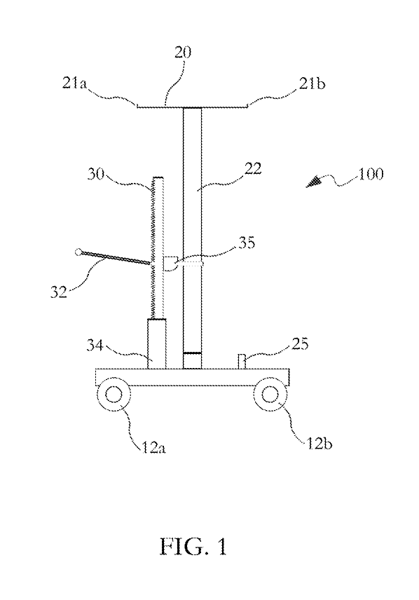

In reference to FIG. 1, a battery lift jack 100 according to the present invention is depicted. The battery lift 100 includes a platform 20 that is suspended on a platform pedestal 22. The platform pedestal 22 is secured to a base that is provided on four wheels. FIG. 1 depicts one side of the battery lift according to the present invention. Wheels 12a, 12b are shown supporting the base of the battery lift 100. The platform pedestal 22 is secured to the base and moves vertically to raise the platform 20 to the desired height. Movement of the platform pedestal 22 is accomplished by utilizing a jack that is connected to the platform 20 via connector 35. The connector 35 joins the platform pedestal 22 to the jack column 30. This connector 35 is moved vertically along the jack column 30 through the use of the jack handle 32. A user manually manipulates the jack handle 32 to raise the platform 20 vertically to the desired height. During use the user places the refrigeration battery on the platform 20 which further includes lips 21a, 21b. The lift 100 helps to secure the battery in a stationary position while the platform is moved vertically.

Other features related to the jack assembly include a base 34 which supports the jack column 30. The base 34 is securely connected to the base of the battery lift 100. The handle 32 is maneuvered to vertically move the connector 35 along the column 30 and may be actuated to lower or raise the connector 35 as desired. A handle holder 25 is also shown on the base of the battery lift 100. This handle holder provides a means to attach and hold a handle to maneuver the battery lift assembly to the desired location for use.

The battery lift 100 may be maneuvered up to 30 inches in height to lift the battery to the appropriate level. The components of the platform may be manufactured of steel. Also the base and column may be manufactured of steel materials. The battery lift according to present invention may lift objects up to 80 pounds in weight and is easily operated by a single user. Use of the battery lift alleviates the necessity for manually lifting batteries into refrigeration units.

What is claimed is:

1. A battery lift jack assembly for lifting batteries comprising:
a. a platform for placement of a battery, where the platform is suspended on a platform pedestal, where the pedestal moves vertically to raise the platform to a desired height;
b. a base that is provided on wheels, where the platform pedestal is secured on the base;
c. a jack assembly for moving the platform pedestal vertically; and
d. a connector, where the connector joins the platform pedestal to the jack assembly and moves vertically along the jack column.

2. The battery lift jack assembly according to claim 1, where the jack assembly includes a jack handle and jack column.

3. The battery lift jack assembly according to claim 1, where the platform further includes lips, which help to secure the battery in a stationary position while the platform, is moved vertically.
